(19) United States
(12) Patent Application Publication
(10) Pub. No.: US 2013/0120693 A1
(43) Pub. Date: May 16, 2013

(54) POLARIZING PLATE AND LIQUID CRYSTAL DISPLAY INCLUDING THE SAME

(71) Applicants: Dong Yoon SHIN, Uiwang-si (KR); Kwang Ho SHIN, Uiwang-si (KR); Eun Kyeong SEO, Uiwang-si (KR); Eun Su PARK, Uiwang-si (KR)

(72) Inventors: Dong Yoon SHIN, Uiwang-si (KR); Kwang Ho SHIN, Uiwang-si (KR); Eun Kyeong SEO, Uiwang-si (KR); Eun Su PARK, Uiwang-si (KR)

(21) Appl. No.: 13/671,652

(22) Filed: Nov. 8, 2012

(30) Foreign Application Priority Data
Nov. 10, 2011 (KR) 10-2011-0117191

(51) Int. Cl. G02F 1/1335

(52) U.S. Cl. 349/96

(57) ABSTRACT

A polarizing plate includes a polarizer and a protective film facing a surface of the polarizer, the protective film having a water vapor transmission rate (WVTR) of about 100 g/m²·day or less at a temperature of 40° C. and a relative humidity of 90%, and a solventless adhesive interposed between and contacting the polarizer and the protective film.

### CROSS-REFERENCE TO RELATED APPLICATION

The present application claims priority under 35 U.S.C. §119 to Korean Patent Application No. 10-2011-0117191, filed on Nov. 10, 2011, in the Korean Intellectual Property Office, and entitled: “Polarizing Plate And Liquid Crystal Display Including The Same,” which is incorporated by reference herein in its entirety.

### BACKGROUND

1. Field

Embodiments relate to a polarizing plate and a liquid crystal display (LCD) including the same.

2. Description of the Related Art

Polarizing plates may be placed on both sides of a liquid crystal cell to control oscillation of light in order to visualize a display pattern of a LCD. Applications of LCDs include small devices, notebook computers, monitors, color projectors, televisions, car navigation systems, personal phones such as cellular phones, outdoor/indoor measurement instruments, and the like. In applications such as monitors and televisions, a backlight unit having high brightness may be used, which may require a high performance polarizing plate.

### SUMMARY

Embodiments are directed to a polarizing plate, including a polarizer, a protective film facing a surface of the polarizer, the protective film having a water vapor transmission rate (WVTR) of about 100 g/m²·day or less at a temperature of 40° C. and a relative humidity of 90%, and a solventless adhesive interposed between and contacting the polarizer and the protective film.

The polarizing plate may further include another protective film facing an opposite surface of the polarizer and being configured to be placed on a liquid crystal panel, the solventless adhesive also being interposed between and contacting the polarizer and the other protective film.

The other protective film may have a WVTR of about 100 g/m²·day or less at a temperature of 40° C. and a relative humidity of 90%.

The protective film and the other protective film may be formed of a same material.

The WVTR may be about 1 g/m²·day to about 10 g/m²·day at a temperature of 40° C. and a relative humidity of 90%.

The protective film may include at least one of cellulose, polyester, cyclic polyolefin, polycarbonate, polyethersulfone, polysulfone, polyamide, polyimide, polyolefin, polyarylate, polyvinyl alcohol, polyvinyl chloride, or polyvinylidene chloride.

The protective film may include at least one of polyester, cyclic polyolefin, polycarbonate, polyethersulfone, polysulfone, polyamide, polyimide, polyolefin, polyarylate, polyvinyl alcohol, polyvinyl chloride, or polyvinylidene chloride.

The solventless adhesive may be formed from about 90 wt % to about 99 wt % of a curable composition and about 1 wt % to about 10 wt % of a curing agent, the curable composition including at least one of a urethane polymer, a (meth)acrylic monomer, a urethane monomer, an epoxy monomer, an epoxy (meth)acrylic monomer, or a urethane (meth)acrylic monomer.

The solventless adhesive may be a cured mixture of an isocyanate curing agent, a urethane polymer, and a reactive (meth)acrylic monomer.

The mixture may consist of about 5 parts by weight of a toluene diisocyanate adduct of trimethylolpropane as the isocyanate curing agent, and about 95 parts by weight of a solution of the urethane polymer and the reactive (meth)acrylic monomer.

The protective film may have a thickness of about 10 μm to about 200 μm.

The protective film may have a phase retardation (R₀) of higher than about 10,000 nm at a wavelength of 550 nm.

The protective film may be attached to a surface of the polarizing plate facing a user, an opposite surface of the polarizing plate being configured to be placed on a liquid crystal panel.

The polarizing plate may have a variation rate in light transmission of about 1% or less at a wavelength of 400 nm to 780 nm, the variation rate in the light transmission being obtained by Equation 1:

Variation rate in light transmission (%)=|B−A|/A×100, [Equation 1]
wherein A is an average value of initial light transmission of the polarizing plate, and B is an average value of light transmission of the polarizing plate measured after the polarizing plate has been left to stand for 500 hours at 60° C. and 90 RH %.

Embodiments are also directed to a liquid crystal display including a polarizing plate according to an embodiment.

### BRIEF DESCRIPTION OF THE DRAWING

Features will become apparent to those of skill in the art by describing in detail example embodiments with reference to the attached drawing, in which:

FIG. 1 illustrates a polarizing plate according to an embodiment.

### DETAILED DESCRIPTION

Example embodiments will now be described more fully hereinafter with reference to the accompanying drawing; however, they may be embodied in different forms and should not be construed as limited to the embodiments set forth herein. Rather, these embodiments are provided so that this disclosure will be thorough and complete, and will fully convey example implementations to those skilled in the art.

In the drawing FIGURE, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present.

In an embodiment, a polarizing plate includes a polarizer and a protective film attached to at least one surface of the polarizer via an adhesive layer. The protective film may have a water vapor transmission rate (WVTR) of, e.g., about 100 g/m²·day or less at a temperature of 40° C. and a relative humidity of 90%. The adhesive layer may be formed of a solventless adhesive.

A protective film may be attached to a single surface or both surfaces (faces) of the polarizer.

The protective film may have a WVTR of about 100 g/m²·day or less, as measured in a direction of film thickness at 40° C. and 90 RH % for 24 hours. Within this range of the WVTR, the polarizing plate may provide enhanced durability by restricting moisture from the polarizer, which may be vulnerable to moisture. Further, the solventless adhesive may avoid problems such as moisture evaporation. For example, the protective film may have a WVTR of about 1 g/m²·day to about 10 g/m²·day.

The WVTR of the protective film can be measured within a thickness limit ranging from about 10 μm to about 200 μm. For example, the WVTR can be measured by MOCON testing, which is carried out using nitrogen as a carrier gas at a temperature of 40° C., a relative humidity of 90%, and a pressure of 760 mmHg.

Example materials for the protective film include celluloses, polyesters, cyclic polyolefins, polycarbonates, polyether sulfones, polysulfones, polyamides, polyimides, polyolefins, polyarylates, polyvinyl alcohols, polyvinyl chlorides, polyvinylidene chlorides, and mixtures thereof. For example, polyester films formed of polyethylene terephthalate (PET), cyclic olefin polymer (COP) films, or cellulose films including triacetylcellulose (TAC) may be used.

The protective film may have a thickness of about 10 μm to about 200 μm, preferably about 30 μm to about 120 μm.

When the polarizing plate includes a first protective film attached to an upper surface of the polarizer and a second protective film attached to a lower surface thereof, the first and second protective films may be the same or different from each other in terms of WVTR, material, thickness, and the like. For example, the first protective film may have a WVTR of about 100 g/m²·day or less at 40° C. and 90 RH %. In an implementation, the first and second protective films may each have a WVTR of about 100 g/m²·day or less at 40° C. and 90 RH %.

The protective film may be a transparent film (e.g., transparent over a 400 to 780 nm wavelength range), and may have a phase retardation (R₀) of higher than about 10,000 nm at a wavelength of 550 nm. Within this range, a rainbow type light reflection pattern may be prevented in use of the polarizing plate. For example, the phase retardation (R₀) may range from about 10,100 nm to about 50,000 nm.

The polarizer may be formed of a suitable polyvinyl alcohol film, which may be fabricated using various methods. For example, the polarizer may be formed of a partially formalized polyvinyl alcohol film, a modified polyvinyl alcohol film such as an acetoacetyl group-modified polyvinyl alcohol film, or the like.

The polyvinyl alcohol film preferably has a degree of polymerization ranging from about 1,700 to about 4,000. Within this range, the polyvinyl alcohol film may be used as a polarization material that provides satisfactory optical characteristics when used for a polarizing film.

The polarizer may be manufactured by dyeing a polyvinyl alcohol film with iodine or dichroic dyes, followed by stretching the dyed polyvinyl alcohol film in a certain direction. Specifically, the polarizer may be manufactured by swelling, dyeing, and stretching according to known processes.

The polarizer may have a thickness of, e.g. about 15 μm to about 50 μm.

The protective film may be stacked on the polarizer via an adhesive layer.

The adhesive layer may be formed of a solventless adhesive that does not contain a solvent. In an implementation, the adhesive layer is formed of an adhesive composition that does not contain water. The solventless adhesive may contain a photocurable or heat-curable composition and a curing agent.

Examples of the curable composition include urethane polymers, (meth)acrylates, urethanes, epoxies, epoxy (meth)acrylates, urethane (meth)acrylate monomers, mixtures thereof, etc. For example, the curable composition may include a (meth)acrylate monomer containing a curable group such as a vinyl group. Such a curable composition may be, e.g., a C₁-C₁₅ straight or branched alkyl group containing (meth)acrylate, a C₅-C₁₅ alicyclic group containing (meth)acrylate, a C₆-C₂₀ aryl group containing (meth)acrylate, a C₇-C₂₀ aralkyl group containing (meth)acrylate, or a mixture thereof. For example, the curable composition may include one or more of methyl(meth)acrylate, n-butyl(meth)acrylate, iso-butyl(meth)acrylate, neo-pentyl(meth)acrylate, lauryl(meth)acrylate, cyclohexyl(meth)acrylate, phenyl(meth)acrylate, benzyl(meth)acrylate, etc.

The curing agent may be a photocurable or heat-curable curing agent, such as an isocyanate curing agent.

The solventless adhesive may contain about 90 wt % to about 99 wt % of the curable composition and about 1 wt % to about 10 wt % of the curing agent. For example, the solventless adhesive may contain about 95 wt % to about 99 wt % of the curable composition and about 1 wt % to about 5 wt % of the curing agent.

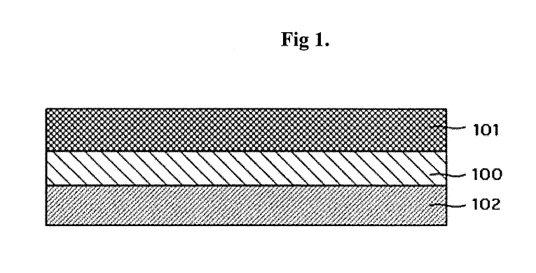

FIG. 1 shows a polarizing plate according to an embodiment.

In the example embodiment shown in FIG. 1, protective films 101, 102 are attached to respective surfaces of a polarizer 100. The attachment may be via adhesive layers formed by a solventless adhesive. Referring to the protective film attached to an upper surface of the polarizer as a first protective film 101 and the protective film attached to a lower surface of the polarizer as a second protective film 102, the first protective film preferably has a WVTR of about 100 g/m²·day or less at 40° C. and 90 RH %. For example, the WVTR may be about 1 g/m²·day to about 10 g/m²·day. Examples of materials that may be included in the first protective film include polyesters including polyethylene terephthalate (PET), cyclic polyolefins, polycarbonates, polyether sulfones, polysulfones, polyamides, polyimides, polyolefins, polyarylates, polyvinyl alcohols, polyvinyl chlorides, polyvinylidene chlorides, etc.

In an embodiment, the first protective film may have a phase retardation (R₀) of higher than about 10,000 nm, preferably from about 10,100 nm to about 50,000 nm, at a wavelength of 550 nm.

The second protective film may have a WVTR of about 100 g/m²·day or less, or a WVTR of higher than about 100 g/m²·day, at a temperature of 40° C. and a relative humidity of 90%. For example, the second protective film may have a WVTR of about 100 g/m²·day or less at 40° C. and 90 RH %. In an implementation, the WVTR may be about 1 g/m²·day to about 10 g/m²·day.

The polarizing plate may be fabricated by a suitable method. For example, the fabrication method may include attaching a protective film to a polyvinyl alcohol film, which has been subjected to dyeing, stretching, and the like, using a solventless adhesive, and curing the solventless adhesive via photo- or heat-curing.

The polarizing plate may have a variation rate in light transmission of about 1% or less, as obtained by the following Equation 1:

Variation rate in light transmission (%)=|B−A|/A×100, [Equation 1]

wherein A is an average value of initial light transmission of the polarizing plate, and B is an average value of light transmission of the polarizing plate measured after the polarizing plate has been left to stand for 500 hours at 60° C. and 90 RH %.

Within this range, the polarizing plate may have improved durability. For example, the variation rate in light transmission may range from about 0.1% to about 1%.

In an implementation, the variation in light transmission rate can be calculated by averaging values of light transmission, which are measured on a polarizing plate having a thickness of about 60 μm to about 220 μm at intervals of 2 nm at a wavelength from about 400 nm to about 780 nm.

Another embodiment provides a liquid crystal display that includes a polarizing plate according to an embodiment.

Specifically, in the liquid crystal display, the polarizing plate may be used for one or both of a front polarizing plate (which is placed on a front surface, i.e., a viewing surface, of a liquid crystal display panel) and a rear polarizing plate (which is placed on a rear surface of the liquid crystal display panel, that is, between a backlight unit and the liquid crystal panel).

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

Specifications of the components used in the Examples and Comparative Examples are as follows.

First and second protective films were selected from films as specified below. For convenience of description, a protective film attached to an upper surface of a polarizing plate is referred to as a “first protective film”, and a protective film attached to a lower surface of the polarizing plate and placed on a liquid crystal panel is referred to as a “second protective film”.

(A) Films having a WVTR of 100 g/m²·day or less at 40° C. and 90 RH %:
(a1) PET film having a WVTR of 8 g/m²·day and a thickness of 80 μm (COSMOSHINE, Toyobo Co., Ltd.)
(a2) COP film having a WVTR of 5 g/m²·day and a thickness of 80 μm (ZEONOR, Zeon Co., Ltd.)
   (B) Films having a WVTR of above 100 g/m²·day at 40° C. and 90 RH %:
(b1) TAC film having a WVTR of 800 g/m²·day and a thickness of 80 μm (FujiTAC, Fuji Co., Ltd.)
(b2) LR-film having a WVTR of 180 g/m²·day and a thickness of 85 μm, prepared by coating the TAC film with a hard coating or anti-reflective coating (LR-film, Toppan Co., Ltd.)
   (C) Solventless adhesive prepared by adding 5 parts by weight of an isocyanate curing agent (toluene diisocyanate adducts of trimethylolpropane; AK-75, Aekyung Chemical Co., Ltd.) to 95 parts by weight of a solution of a urethane polymer and a reactive (meth)acrylic monomer.
   (D) Aqueous adhesive free from a curable composition (POVAL, Kuraray Co., Ltd.)

### Examples 1-3

A 75 μm thick polyvinyl alcohol film (degree of polymerization: 2400, degree of saponification: 99% or more) was swollen in an aqueous solution at 25° C., and dyed in a dyeing solution at 30° C. in a dyeing bath. Then, the dyed polyvinyl alcohol film was additionally stretched in a boric acid solution at 55° C., thereby preparing a polyvinyl alcohol film that had a final elongation of 6 times an initial elongation thereof. Then, the polyvinyl alcohol film was dried for 3 minutes in a chamber at 50° C., preparing a 20 μm thick polarizer. Then, first and second protective films having compositions as listed in Table 1 were attached to the polarizer using the solventless adhesive, followed by curing the adhesive by UV curing, thereby preparing polarizing plates.

### Comparative Examples 1-4

The polarizing plates of Comparative Examples 1-4 were prepared in the same manner as in Examples 1-4 except that the first and second protective films had compositions as listed in Table 1 and the solventless adhesive was replaced by an aqueous adhesive.

### Experimental Example

### Evaluation of Physical Properties of Polarizing Plates

Light transmission values were measured on the 180 μm thick polarizing plate, which was prepared in each of the examples and the comparative examples, at intervals of 2 nm at a wavelength of about 400 to 780 nm, using a spectrometer V-7100 (Jasco Co., Ltd.), and the measured light transmission values were averaged. Then, variation in the light transmission rate was calculated by Equation 1:

Variation rate in light transmission (%)=|B−A|/A×100, [Equation 1]

wherein A is an average value of initial light transmission of the polarizing plate, and B is an average value of light transmission of the polarizing plate measured after the polarizing plate has been left to stand for 500 hours at 60° C. and 90 RH %.

TABLE 1

| | WVTR | WVTR | | Variation rate in |
|---|---|---|---|---|
| | (g/m² · day) | (g/m² · day) | | light transmission |
| | of 1st film | of 2nd film | Adhesive | (%) |
| Example 1 | 8 | 8 | Solventless | 0.6 |
| Example 2 | 5 | 8 | Solventless | 0.5 |
| Example 3 | 8 | 180 | Solventless | 0.8 |
| Comparative | 180 | 800 | Aqueous | 1.8 |
| example 1 | | | | |
| Comparative | 5 | 800 | Aqueous | 1.1 |
| example 2 | | | | |
| Comparative | 180 | 8 | Aqueous | 1.3 |
| example 3 | | | | |
| Comparative | 180 | 800 | Solventless | 1.5 |
| example 4 | | | | |

As shown in Table 1, the polarizing plates prepared in Examples 1-3, in which the WVTRs of the protective films were 100 g/m²·day or less and the adhesive was a solventless adhesive, showed a low variation rate in light transmission. Thus, the polarizing plates prepared in Examples 1-3 may provide improved durability. The polarizing plates prepared in Comparative Examples 1-4, in which the WVTRs of the protective films were above 100 g/m²·day and the adhesive was an aqueous adhesive composition, showed high variation in light transmission rate, which may reduce durability.

By way of summation and review, a polarizing plate may include a polarizer and protective films attached to both surfaces of the polarizer. The polarizer may be formed of a polyvinyl alcohol film, in which case highly hygroscopic properties of the polyvinyl alcohol film may cause deterioration in image quality and durability of the polarizing plate when the polyvinyl alcohol film. Thus, a protective film may be stacked on the polarizer in order to protect the polarizer, which may be vulnerable to moisture.

When used as a protective film, a film having low moisture transmission rate may be used to mitigate or compensate for moisture vulnerability of a polyvinyl alcohol film. However, an aqueous adhesive composition may not exhibit sufficient volatilization of moisture during drying in a process of fabricating a polarizing plate, and thus may reduce durability of the polarizing plate.

As described above, an embodiment relates to a polarizing plate that includes a protective film having a water vapor transmission rate in a particular range, the protective film being bonded to the polarizer via a solventless adhesive. Such a configuration may mitigate moisture vulnerability of the polarizer while improving durability of the polarizing plate. Another embodiment relates to an LCD including the polarizer.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A polarizing plate, comprising:
a polarizer;
a protective film facing a surface of the polarizer, the protective film having a water vapor transmission rate (WVTR) of about 100 g/m²·day or less at a temperature of 40° C. and a relative humidity of 90%; and
a solventless adhesive interposed between and contacting the polarizer and the protective film.

2. The polarizing plate as claimed in claim 1, wherein the polarizing plate further comprises another protective film facing an opposite surface of the polarizer and being configured to be placed on a liquid crystal panel, the solventless adhesive also being interposed between and contacting the polarizer and the other protective film.

3. The polarizing plate as claimed in claim 2, wherein the other protective film has a WVTR of about 100 g/m²·day or less at a temperature of 40° C. and a relative humidity of 90%.

4. The polarizing plate as claimed in claim 2, wherein the protective film and the other protective film are formed of a same material.

5. The polarizing plate as claimed in claim 1, wherein the WVTR is about 1 g/m²·day to about 10 g/m²·day at a temperature of 40° C. and a relative humidity of 90%.

6. The polarizing plate as claimed in claim 1, wherein the protective film includes at least one of cellulose, polyester, cyclic polyolefin, polycarbonate, polyethersulfone, polysulfone, polyamide, polyimide, polyolefin, polyarylate, polyvinyl alcohol, polyvinyl chloride, or polyvinylidene chloride.

7. The polarizing plate as claimed in claim 1, wherein the protective film includes at least one of polyester, cyclic polyolefin, polycarbonate, polyethersulfone, polysulfone, polyamide, polyimide, polyolefin, polyarylate, polyvinyl alcohol, polyvinyl chloride, or polyvinylidene chloride.

8. The polarizing plate as claimed in claim 1, wherein the solventless adhesive is formed from about 90 wt % to about 99 wt % of a curable composition and about 1 wt % to about 10 wt % of a curing agent, the curable composition including at least one of a urethane polymer, a (meth)acrylic monomer, a urethane monomer, an epoxy monomer, an epoxy (meth)acrylic monomer, or a urethane (meth)acrylic monomer.

9. The polarizing plate as claimed in claim 1, wherein the solventless adhesive is a cured mixture of an isocyanate curing agent, a urethane polymer, and a reactive (meth)acrylic monomer.

10. The polarizing plate as claimed in claim 9, wherein the mixture consists of:
about 5 parts by weight of a toluene diisocyanate adduct of trimethylolpropane as the isocyanate curing agent; and
about 95 parts by weight of a solution of the urethane polymer and the reactive (meth)acrylic monomer.

11. The polarizing plate as claimed in claim 1, wherein the protective film has a thickness of about 10 μm to about 200 μm.

12. The polarizing plate as claimed in claim 1, wherein the protective film has a phase retardation (R₀) of higher than about 10,000 nm at a wavelength of 550 nm.

13. The polarizing plate as claimed in claim 12, wherein the protective film is attached to a surface of the polarizing plate facing a user, an opposite surface of the polarizing plate being configured to be placed on a liquid crystal panel.

14. The polarizing plate as claimed in claim 1, wherein the polarizing plate has a variation rate in light transmission of about 1% or less at a wavelength of 400 nm to 780 nm, the variation rate in the light transmission being obtained by Equation 1:
Variation rate in light transmission (%)=|B−A|/A×100, [Equation 1]
wherein A is an average value of initial light transmission of the polarizing plate, and B is an average value of light transmission of the polarizing plate measured after the polarizing plate has been left to stand for 500 hours at 60° C. and 90 RH %.

15. A liquid crystal display comprising the polarizing plate as claimed in claim 1.
